(19) United States
(12) Patent Application Publication
(10) Pub. No.: US 2024/0134378 A1
(43) Pub. Date: Apr. 25, 2024

(54) Automated Recovery Assistance for Incapacitated Mobile Robots

(71) Applicant: ZEBRA TECHNOLOGIES CORPORATION, Lincolnshire, IL (US)

(72) Inventors: Melonee Wise, San Jose, CA (US); Derek King, Seattle, WA (US); Jenna Guergah, Santa Cruz, CA (US)

(21) Appl. No.: 17/971,322

(22) Filed: Oct. 20, 2022

(51) Int. Cl. G05D 1/02; B60L 53/36

(52) U.S. Cl. CPC G05D 1/0225; B60L 53/36; G05D 1/0276; G05D 2201/0216

(57) ABSTRACT

A method includes: receiving, at a mobile robot from a central server, a rescue command including a rescue location corresponding to an incapacitated mobile robot; controlling a locomotive assembly of the mobile robot to travel towards the rescue location; capturing, using a sensor of the mobile robot, sensor data representing the rescue location; at the mobile robot, identifying the incapacitated mobile robot from the sensor data; controlling the locomotive assembly to position the mobile robot in a predetermined pose relative to the incapacitated robot; and controlling a charging interface of the mobile robot to transfer energy from a battery of the mobile robot to a battery of the incapacitated mobile robot.

### BACKGROUND

Autonomous or semi-autonomous mobile robots can be deployed in facilities such as warehouses, manufacturing facilities, healthcare facilities, or the like, e.g., to transport items within the relevant facility. Such robots may occasionally become incapacitated, e.g., due to low or exhausted batteries. An incapacitated robot may require time-consuming retrieval and remediation by service staff, and/or may impede the operations of other robots in the facility.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of item-handing mobile robots deployed in a facility.

FIG. 2 is a diagram of certain components of a mobile robot of FIG. 1.

FIG. 3 is a flowchart illustrating a method of automated recovery assistance for incapacitated mobile robots.

FIG. 4 is a diagram illustrating an example performance of block 305 of the method of FIG. 3.

FIG. 5 is a diagram illustrating an example performance of blocks 305 and 310 of the method of FIG. 3.

FIG. 6 is a diagram illustrating an example performance of blocks 305 and 310 of the method of FIG. 3.

FIG. 7 is a diagram illustrating an example performance of blocks 315 and 320 of the method of FIG. 3.

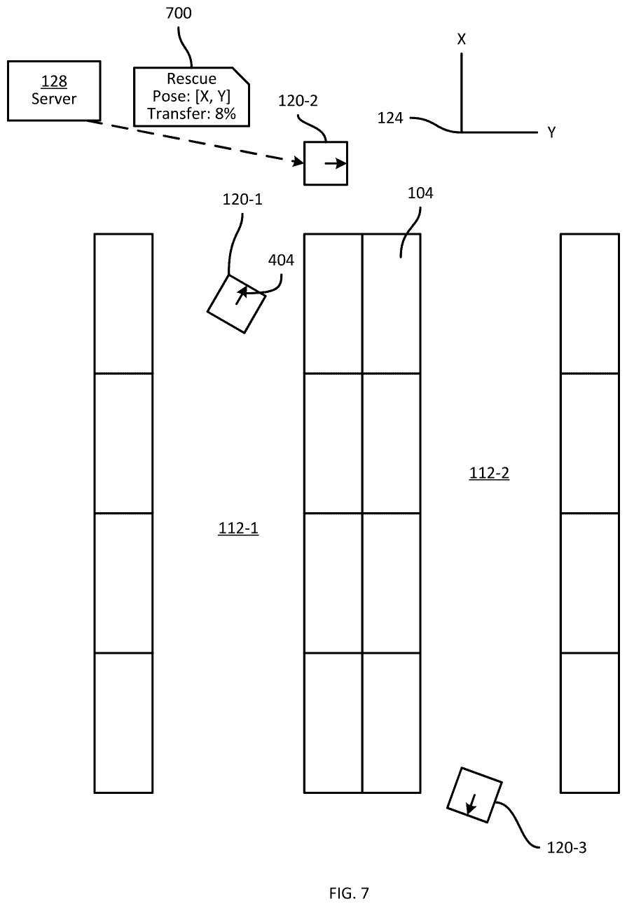

FIG. 8 is a diagram illustrating an example performance of blocks 330 and 335 of the method of FIG. 3.

FIG. 9 is a diagram illustrating an example performance of block 340 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: controlling a locomotive assembly of a first mobile robot to travel towards a rescue location corresponding to a second mobile robot having an incapacitated state; capturing, using a sensor of the first mobile robot, sensor data representing the rescue location; at the first mobile robot, detecting the second mobile robot from the sensor data; controlling the locomotive assembly to position the first mobile robot in a predetermined pose relative to the second mobile robot; and controlling a charging interface of the first mobile robot to transfer energy from a battery of the mobile robot to a battery of the second mobile robot.

Additional examples disclosed herein are directed to a mobile robot, comprising: a sensor; a charging interface; a locomotive assembly; and a processor configured to: control the locomotive assembly of the mobile robot to travel towards a rescue location corresponding to a second mobile robot having an incapacitated state; capture, using the sensor, sensor data representing the rescue location; detect the second mobile robot from the sensor data; control the locomotive assembly to position the mobile robot in a predetermined pose relative to the second mobile robot; and control a charging interface of the mobile robot to transfer energy from a battery of the mobile robot to a battery of the second mobile robot.

Further examples disclosed herein are directed to a method, comprising: receiving, at a first mobile robot, a rescue command containing a rescue location corresponding to a second mobile robot having an incapacitated state; controlling a locomotive assembly of the first mobile robot to travel towards the rescue location; capturing sensor data using a sensor of the first mobile robot, and detecting a current pose of the second mobile robot from the sensor data; determining that a difference between a last known pose of the second mobile robot and the detected current pose of the second mobile robot exceeds a relocalization threshold; and transmitting the detected current pose to the second mobile robot.

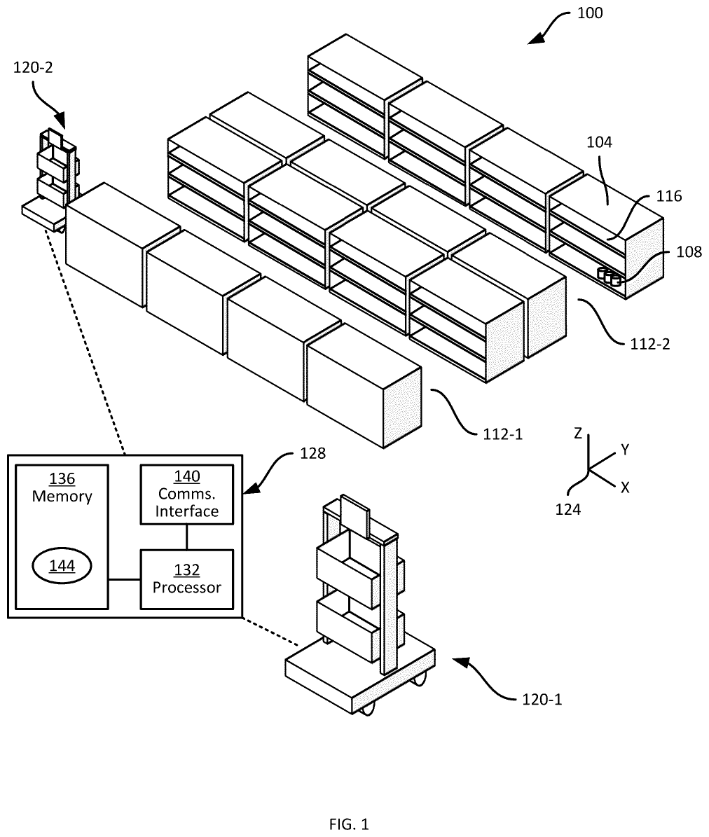

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as aisles 112, and generically referred to as an aisle 112; similar nomenclature is used herein for other components). As shown in FIG. 1, support structures 104 in the form of shelf modules include support surfaces 116 supporting the items 108. The support structures 104 can also include pegboards, bins, or the like, in other examples.

In other examples, the facility 100 can include fewer aisles 112 than shown, or more aisles 112 than shown in FIG. 1. The aisle 112, in the illustrated example, are formed by sets of eight support structures 104 (four on each side). The facility can also have a wide variety of other aisle layouts, however. As will be apparent, each aisle 112 is a space open at the ends, and bounded on either side by a support structure 104. The aisle 112 can be travelled by humans, vehicles, and the like. In still further examples, the facility 100 need not include aisles 112, and can instead include assembly lines, or the like.

The items 108 may be handled according to a wide variety of processes, depending on the nature of the facility. In some examples, the facility is a shipping facility, distribution facility, or the like, and the items 108 can be placed on the support structures 104 for storage, and subsequently retrieved for shipping from the facility. Placement and/or retrieval of the items 108 to and/or from the support structures can be performed or assisted by mobile robots, of which two example robots 120-1 and 120-2 are shown in FIG. 1. A greater number of robots 120 can be deployed in the facility 100 than the two robots 120 shown in FIG. 1, for example based on the size and/or layout of the facility 100. Components of the robots 120 are discussed below in greater detail. In general, each robot 120 is configured to transport items 108 within the facility 100.

Each robot 120 can be configured to track its pose (e.g., location and orientation) within the facility 100, e.g., within a coordinate system 124 previously established in the facility 100. The robots 120 can navigate autonomously within the facility 100, e.g., travelling to locations assigned to the robots 120 to receive and/or deposit items 108. The items 108 can be deposited into or onto the robots 120, and removed from the robots 120, by human workers and/or mechanized equipment such as robotic arms and the like deployed in the facility 100. The locations to which each robot 120 navigates can be assigned to the robots 120 by a central server 128. That is, the server 128 is configured to assign tasks to the robots 120. Each task can include either or both of one or more locations to travel to, and one or more actions to perform at those locations. For example, the server 128 can assign a task to the robot 120-1 to travel to a location defined in the coordinate system 124, and to await the receipt of one or more items 108 at that location.

Tasks can be assigned to the robots via the exchange of messages between the server 128 and the robots 120, e.g., over a suitable combination of local and wide-area networks. The server 128 can be deployed at the facility 100, or remotely from the facility 100. In some examples, the server 128 is configured to assign tasks to robots 120 at multiple facilities, and need not be physically located in any of the individual facilities.

The server 128 includes a processor 132, such as one or more central processing units (CPU), graphics processing units (GPU), or dedicated hardware controllers such as application-specific integrated circuits (ASICs). The processor 132 is communicatively coupled with a non-transitory computer readable medium such as a memory 136, e.g., a suitable combination of volatile and non-volatile memory elements. The processor 132 is also coupled with a communications interface 140, such as a transceiver (e.g., an Ethernet controller or the like) enabling the server 128 to communicate with other computing devices, such as the mobile robots 120. The memory 136 can store a plurality of computer-readable instructions executable by the processor 132, such as an application 144 whose execution by the processor 132 configures the processor 132 to manage certain aspects of the operations of the mobile robots 120, including assigning rescue tasks under certain conditions, as discussed below.

As discussed below, the robots 120 are electrically powered, e.g., by one or more on-board batteries. The facility 100 can also include charging infrastructure, such as one or more charging docks (not shown) to which the robots 120 can periodically travel to recharge the above-mentioned batteries. The server 128, for example, can periodically assign charging tasks to the robots 120, instructing the robots 120 to travel to such charging docks.

Under some circumstances, however, the battery of a robot 120 may be sufficiently depleted that the mobile robot 120 is unable to complete a current task, and is also unable to reach a charging dock. The mobile robot 120 may therefore become incapacitated. In general, a mobile robot 120 is referred to as incapacitated if the mobile robot 120 is unable to move under its own power, e.g., because of insufficient stored energy remaining in the battery of the mobile robot 120. As will be apparent to those skilled in the art, a mobile robot 120 may become incapacitated as mentioned above as a result of a faulty battery (e.g., whose capacity has decreased due to age and/or physical damage). In other words, a mobile robot 120 in an incapacitated state may be immobilized, e.g., incapable of moving.

In other examples, a mobile robot 120 may become incapacitated due to mislocalization errors. For example, a mobile robot 120 may accumulate localization error, to the extent that the current pose tracked by the mobile robot 120 in the coordinate system 124 does not reflect the true pose of the mobile robot 120 within the facility 100. The mobile robots 120 can be configured to evaluate the quality of the current tracked pose (e.g., by generating a confidence score or other metric in association with the tracked pose). The mobile robots 120 can further be configured, e.g., when localization confidence is below a threshold, to travel the facility and collect sensor data (e.g., from cameras, laser scanners, and the like, as discussed below) to compare with a predetermined map of the facility and attempt to improve or correct their localization. In some cases, a mobile robot 120 may become mislocalized and exhaust the on-board battery travelling the facility 100 in an attempt to relocalize itself. In some examples, a mobile robot 120 may enter an incapacitated state and stop travelling, before exhausting the on-board battery, e.g., if localization confidence is below a threshold for a predetermined period of time. In such examples, the mobile robot 120 may not be immobilized, because sufficient power remains to move, but may still be considered incapacitated.

An incapacitated mobile robot 120 may interfere with item handling operations in the facility 100, e.g., because that mobile robot 120 can no longer perform tasks assigned by the server 128. Further, the incapacitated mobile robot 120 may impede the travel of other mobile robots 120 in the facility 100. Recovery of an incapacitated mobile robot 120 may include directing human service staff to seek the incapacitated mobile robot 120 and transport the incapacitated mobile robot 120 to a service area for charging or other maintenance. Locating and transporting an incapacitated mobile robot 120, however, can be a time-consuming process, and may involve the deployment of additional staff to the facility 100.

To mitigate the above-mentioned impacts of incapacitated mobile robots 120, at least some of the mobile robots 120 deployed in the facility 100, and in some examples each of the mobile robots 120 deployed in the facility 100, are configured to execute rescue tasks. A rescue task includes travelling autonomously, by a “rescue” mobile robot 120, to the location of the incapacitated mobile robot 120. The rescue task further includes transferring energy from a battery of the rescue mobile robot 120 to the battery of the incapacitated mobile robot 120, and can also include transferring a corrected localization to the incapacitated mobile robot 120. The performance of rescue tasks by the mobile robots 120 can, in other words, provide automated recovery assistance to incapacitated mobile robots 120, reducing the impact of incapacitation on operations within the facility 100.

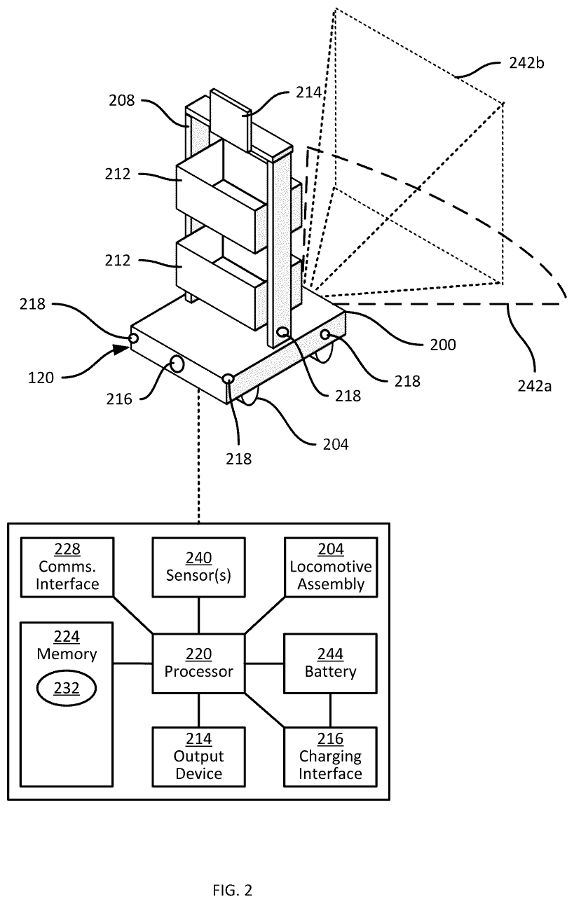

Before discussing the functionality implemented by the robots 120 in greater detail, certain components of the robots 120 are discussed with reference to FIG. 2. As shown in FIG. 2, each robot 120 includes a chassis 200 supporting various other components of the robot 120. In particular, the chassis 200 supports a locomotive assembly 204, such as one or more electric motors driving a set of wheels, tracks, or the like. The locomotive assembly 204 can include one or more sensors such as a wheel odometer, an inertial measurement unit (IMU), and the like.

The chassis 200 also supports receptacles, shelves, or the like, to support items 108 during transport. For example, the robot 120 can include a selectable combination of receptacles 212. In the illustrated example, the chassis 200 supports a rack 208, e.g., including rails or other structural features configured to support receptacles 212 at variable heights above the chassis 200. The receptacles 212 can therefore be installed and removed to and from the rack 208, enabling distinct combinations of receptacles 212 to be supported by the robot 120.

The robot 120 can also include an output device, such as a display 214. In the illustrated example, the display 214 is mounted above the rack 208, but it will be apparent that the display 214 can be disposed elsewhere on the robot 120 in other examples. The display 214 can include an integrated touch screen or other input device, in some examples, The robot 120 can also include other output devices in addition to or instead of the display 214. For example, the robot 120 can include one or more speakers, light emitters such as strips of light-emitting diodes (LEDs) along the rack 208, and the like.

The chassis 200 further supports a charging interface 216, which can include a charging port (e.g., a male or female charging connector), a wireless charging surface, or a combination thereof. The charging interface 216 also includes circuitry and/or a charge controller configured to receive or dispense electrical energy via the charging port or surface.

The chassis 200 can also support one or more markers 218, such as retroreflective markers or the like, on an exterior of the chassis 200. The markers 218 can be disposed in numbers and distribution to enable identification of the mobile robot 120 from sensor data such as images, laser scan data, or the like. For example, each mobile robot 120 can be equipped with a unique set of markers 218, such that an image and/or other sensor data depicting at least a portion of the mobile robot 120 can be used to identify the mobile robot 120. In other examples, each mobile robot 120 can carry the same arrangement of markers 218, permitting identification of mobile robots 120 in general from sensor data, but not necessarily distinction of one mobile robot 120 from another. In further examples, the markers 218 can be implemented as one or more three-dimensional objects, e.g., including a set of robustly identifiable edges, reflective surfaces or the like.

The chassis 200 of the robot 120 also supports various other components, including a processor 220, e.g., one or more CPUs, GPUs, or dedicated hardware controllers such as ASICs. The processor 220 is communicatively coupled with a non-transitory computer readable medium such as a memory 224, e.g., a suitable combination of volatile and non-volatile memory elements. The processor 220 is also coupled with a communications interface 228, such as a wireless transceiver enabling the robot 120 to communicate with other computing devices, such as the server 128 and other robots 120.

The memory 224 stores various data used for autonomous or semi-autonomous navigation, including an application 232 executable by the processor 220 to implement navigational and other task execution functions. In some examples, the above functions can be implemented via multiple distinct applications stored in the memory 224.

The chassis 200 can also support a sensor 240, such as one or more cameras and/or depth sensors (e.g., lidars, depth cameras, time-of-flight cameras, or the like) coupled with the processor 220. The sensor(s) 240 are configured to capture image and/or depth data depicting at least a portion of the physical environment of the robot 120. Data captured by the sensor(s) 240 can by used by the processor 220 for navigational purposes, e.g., path planning, obstacle avoidance, and the like, as well as for updating a map of the facility in some examples.

The sensors 240 have respective fields of view (FOVs). For example, a first FOV 242a corresponds to a laser scanner, such as a lidar sensor disposed on a forward-facing surface of the chassis 200. The FOV 242a can be substantially two-dimensional, e.g., extending forwards in a substantially horizontal plane. A second FOV 242b corresponds to a camera (e.g., a depth camera, a color camera, or the like) also mounted on the forward-facing surface of the chassis 200. As will be apparent, a wide variety of other optical sensors can be disposed on the chassis 200 and/or the rack 208, with respective FOVs 242.

The components of the robot 120 that consume electrical power can be supplied with such power from a battery 244, e.g., implemented as one or more rechargeable batteries housed in the chassis 200 and connected with the charging interface 216. The charging interface 216, in other words, is controllable by the processor 220 to transfer energy from the battery 244 to an external sink, such as an incapacitated mobile robot 120, or the transfer energy from an external source (e.g., another mobile robot 120, or a charging dock).

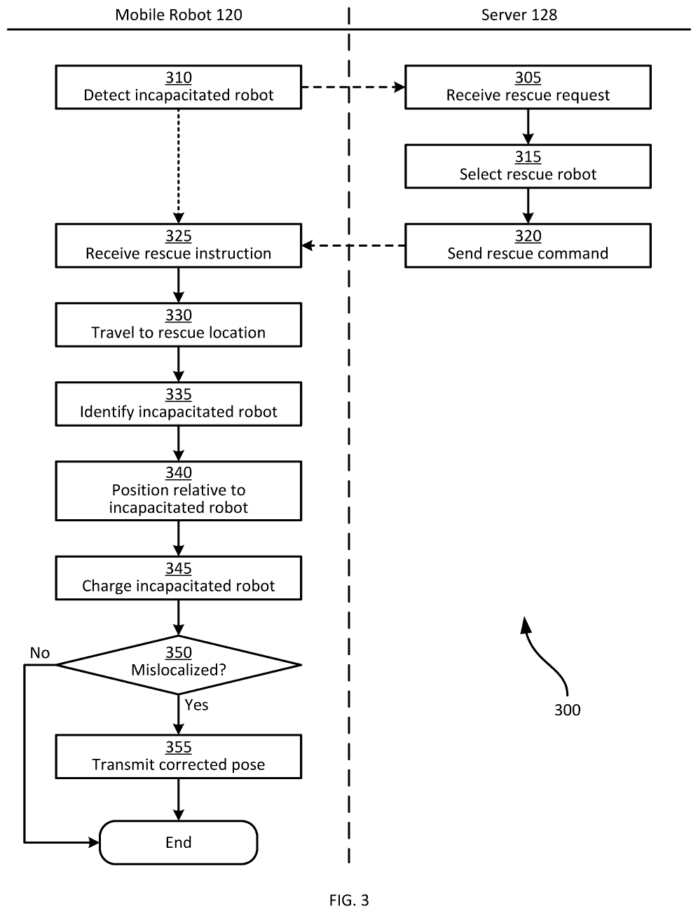

Turning to FIG. 3, a method 300 of automated recovery assistance for incapacitated mobile robots is illustrated. The method 300 is described below in conjunction with its example performance in the facility 100. In particular, as indicated in FIG. 3, certain blocks of the method 300 are performed by a mobile robot 120, e.g., via execution of the application 232 by the processor 220, while other blocks of the method 300 are performed by the server 128, e.g., via execution of the application 144 by the processor 132.

At block 305, the server 128 is configured to receive a rescue request message, whether from an incapacitated mobile robot 120, or from another mobile robot 120 that has detected the incapacitated mobile robot 120, as discussed below. In some examples, the request received at block 305 is received from the incapacitated mobile robot 120 itself. For example, each mobile robot 120 can be configured to monitor a current charge level of its battery 244, and to generate a rescue request if the charge level falls below a predetermined threshold. The threshold can be, for example, a shutdown threshold, at which the mobile robot 120 ceases operation of subsystems such as the locomotive assembly 204, the sensors 240, and the like. In some examples, prior to reaching the shutdown threshold (e.g., at a charge level of 6%, when the shutdown threshold is 5%), the mobile robot 120 can be configured to position itself away from structures such as support structures 104, walls, and the like, to allow access to the charging interface 216 for rescue.

Upon reaching the shutdown threshold, the mobile robot 120 may continue to operate the processor 220 and communications interface 228, e.g., for long enough to send the rescue request. The rescue request can include the current pose of the mobile robot 120, as well as a current charge level of the mobile robot 120. The rescue request can also include an identifier of the mobile robot 120 (e.g., a serial number or other identifier distinguishing the incapacitated mobile robot 120 from other mobile robots 120).

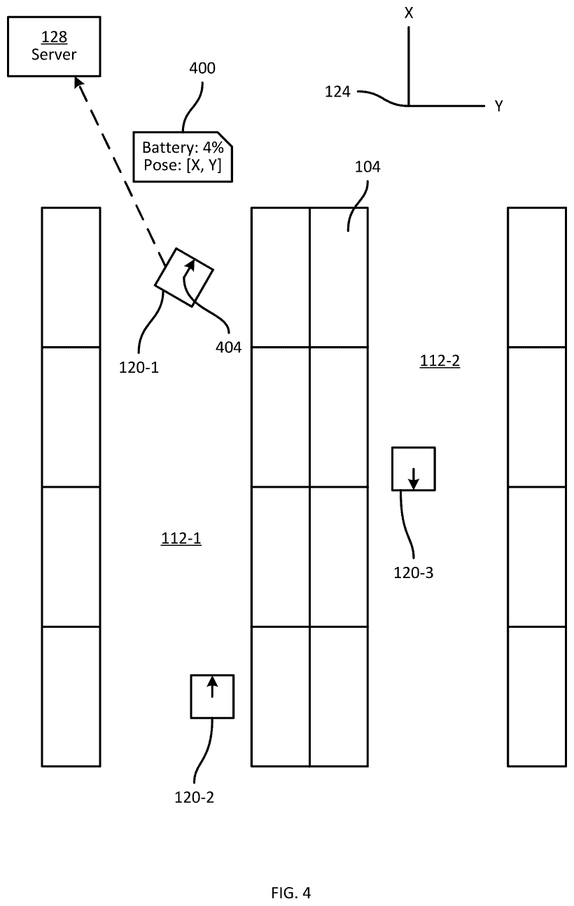

Turning to FIG. 4, an example overhead view of the facility 100 is shown in which the mobile robot 120-1 is incapacitated in the aisle 112-1. The facility 100 also contains the mobile robot 120-2, currently located in the aisle 112-1, and a further mobile robot 120-3, currently located in the aisle 112-2.

The mobile robot 120-1, having become incapacitated, transmits a rescue request 400 to the server 128. The request 400 can include, for example, a current charge level (e.g., 4%) of the battery 244 of the mobile robot 120-1, and can also include a current pose of the mobile robot 120-1. The current pose in the request 400 can define, in the coordinate system 124, the current location (e.g., as X and Y coordinates, assuming that the XZ plane is the floor of the facility 100 and that the Z coordinate is zero) and the current orientation (e.g., as an angle between the X and Y axes of the coordinate system 124). The current pose 404 of the mobile robot 120-1 is illustrated in FIG. 4 as an arrow with its base at the current location of the mobile robot 120-1, and its tip indicating the current orientation of the mobile robot 120-1. In the present example, the current pose 404 as defined in the request 400 substantially matches the true pose of the mobile-robot 120-1. That is, the mobile robot 120-1 is not mislocalized. In other examples, however, a mobile robot 120 may send a current pose to the server 128 (e.g., in a rescue request) that does not match the true pose of the mobile robot 120.

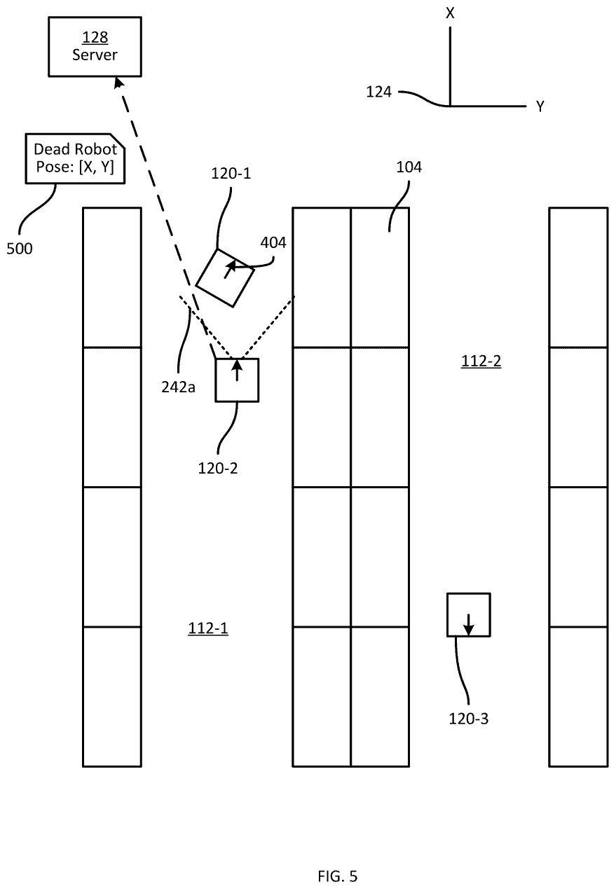

In other examples, as shown in FIG. 5, the rescue request received at block 305 by the server 128 is received from a mobile robot 120 other than the incapacitated mobile robot 120. For example, the mobile robot 120-2 may, at block 310, detect the incapacitated mobile robot 120-1 and transmit a rescue request to the server 128 in response to such detection. For example, the mobile robot 120-2 may, during travel along the aisle 112-1, detect the mobile robot 120-1 in the FOV 242a, e.g., by detecting at least a subset of the markers 218 affixed to the mobile robot 120-1 and matching the detected markers to a predetermined pattern stored in the memory 224 of the mobile robot 120-2.

As will be apparent to those skilled in the art, detecting the mobile robot 120-1 does not necessarily indicate that the mobile robot 120-1 is incapacitated. The mobile robot 120-2 can determine that the mobile robot 120-1 is incapacitated, in some examples, by monitoring for wireless transmissions originating from the mobile robot 120-1 (e.g., having signal strengths indicating likely origination at the mobile robot 120-1). Each mobile robot 120 can be configured, for example, to periodically broadcast a message containing its current pose, direction of travel, and/or other status data (e.g., including battery charge level). When the mobile robot 120-2 does not detect any such transmissions from the mobile robot 120-1 in a threshold time period (e.g., two seconds, although any suitable period of time longer than the frequency with which the robots 120 are configured to broadcast status data may be used), the mobile robot 120-2 can determine that the mobile robot 120-1 is incapacitated.

In response to determining the mobile robot 120-1 is incapacitated, the mobile robot 120-2 can transmit a rescue request 500 to the server 128, e.g., including an indicator that an incapacitated robot 120 has been detected (“dead robot” or any other suitable string, numerical value, or the like), and a detected pose of the mobile robot 120-1. The pose of the mobile robot 120-1 can be determined by the mobile robot 120-2 based on the current tracked pose of the mobile robot 120-2 itself, and the pose of the mobile robot 120-1 relative to the mobile robot 120-2. The markers 218 and the predetermined pattern thereof can be employed by the mobile robot 120-2 to determine the pose of the mobile robot 120-1 relative to the mobile robot 120-2.

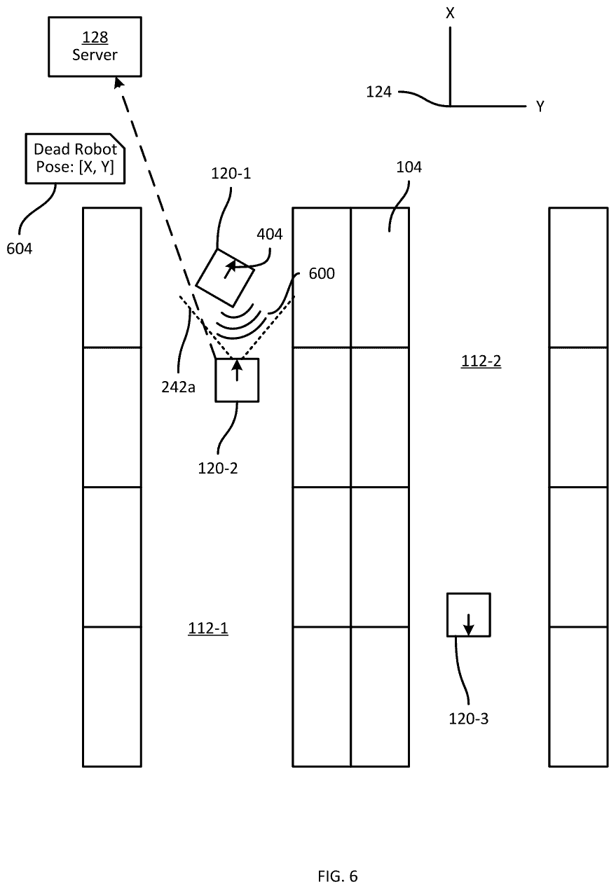

In further examples, the mobile robot 120-2 can detect that the mobile robot 120-1 is incapacitated in response to a wireless transmission from the mobile robot 120-1. For example, as noted above, the mobile robot 120-2 may continue some wireless transmission functions after shutting down the locomotive assembly 204 and/or other subsystems. The mobile robot 120-1 may, as shown in FIG. 6, periodically broadcast data 600 (e.g., via Bluetooth or other suitable short-range transmissions) following incapacitation, e.g., including an indicator that the mobile robot 120-1 is incapacitated. The data 600 may also include an identifier of the mobile robot 120-1, a current charge level of the battery 244 of the mobile robot 120-1, or the like.

The mobile robot 120-2, upon identifying the mobile robot 120-1 via sensor data (e.g., laser scan data captured within the FOV 242a), and detecting a broadcast of the data 600, transmit a rescue request 604, as discussed above in connection with the rescue request 500.

The mechanisms of detecting an incapacitated mobile robot 120-1 discussed above can be implemented simultaneously in the facility 100. For example, each mobile robot 120 can be configured to send a rescue request to the server 128 in response to entering an incapacitated state, and also to broadcast data 600 as long as battery power remains to do so. The combination of the above mechanisms may enable mislocalized mobile robots 120-1 to nevertheless be rescued. For instance, the rescue request 400 may contain an incorrect pose, in the case of an incapacitated and mislocalized mobile robot 120. If the server 128 dispatches another mobile robot 120 to rescue the incapacitated mobile robot 120, as discussed below, the other mobile robot 120 may not succeed in locating the incapacitated mobile robot 120 due to the mislocalization. The rescue operation may therefore fail. Detection of the incapacitated mobile robot 120 by another mobile robot 120, however, may enable dispatch of a further rescue task with accurate localization data for the incapacitated mobile robot 120.

Returning to FIG. 3, at block 315, in response to receiving a rescue request from either the incapacitated mobile robot 120-1 or another mobile robot 120 (e.g., the mobile robot 120-2, as discussed in connection with FIGS. 5 and 6), the server 128 is configured to select one of the mobile robots 120 in the facility 100 (aside from the incapacitated mobile robot 120) as a rescue robot. As discussed below, the rescue robot is later dispatched to travel to the incapacitated mobile robot 120, to charge the battery 244 of the incapacitated mobile robot 120. To select a mobile robot 120 at block 315, the server 128 can omit any mobile robot 120 with a battery charge level below a predetermined threshold (e.g., 50%, or any other suitable threshold). The server 128 can then select the mobile robot 120 located closest to the incapacitated mobile robot 120. In other examples, the server 128 can also prioritize the selection of a mobile robot 120 without another task currently assigned thereto. That is, the server 128 can select the closest mobile robot 120 to the incapacitated mobile robot 120 that is also currently idle.

At block 320, the server 128 is configured to send a rescue command to the mobile robot 120 selected at block 315. The rescue command includes at least a pose of the incapacitated mobile robot 120, e.g., as received from the incapacitated mobile robot 120 itself, or from another mobile robot 120 that detected the incapacitated mobile robot 120 at block 310. The rescue command can also include other data, such as a charge transfer value, indicating a portion of the battery charge level to be transferred from the rescue robot 120 to incapacitated mobile robot 120. The charge transfer value can be determined by the server 128 based, for example, on a distance between the incapacitated mobile robot 120 (i.e., on the last known pose of the incapacitated mobile robot 120, as reported by the incapacitated mobile robot 120 or by another mobile robot 120) and the nearest charging dock to the incapacitated mobile robot 120. In other examples, the charge transfer value can have a predetermined value, e.g., stored in the memory 136 of the server 128.

FIG. 700 illustrates an example performance of blocks 315 and 320. In particular, at block 315 the server 128 selects the mobile robot 120-2 as a rescue robot 120, e.g., because the distance between the mobile robot 120-2 and the mobile robot 120-1 is smaller than a distance between the mobile robot 120-3 and the mobile robot 120-1. The server 128 then transmits a rescue command 700 to the mobile robot 120-2, indicating the last known pose (e.g., the pose 404, as contained in the requests 400, 500, or 604) of the mobile robot 120-1. The command 700 also includes a charge transfer value in this example, although the charge transfer value can be omitted in other examples.

Referring again to FIG. 3, at block 325 the mobile robot 120-2 is configured to receive the command 700. As will be apparent to those skilled in the art, in other examples the command 700 need not be received at the same robot 120 that detected the incapacitated mobile robot 120 at block 310. At block 330, the mobile robot 120-2 is configured to travel towards the pose specified in the command 700. For example, the mobile robot 120-2 can be configured to compute a navigational path through the facility 100 from its current pose to a pose in which the location of the incapacitated mobile robot 120-1 is within the FOV 242 of at least one of the sensors 240 of the mobile robot 120-2.

When the rescue robot 120 (the mobile robot 120-2, in this example) has arrived close enough to the location in the rescue command 700 to place the location within an FOV 242 of the rescue robot 120, at block 335, the rescue robot 120 is configured to capture sensor data using one or more of the sensors 240 and identify the incapacitated mobile robot 120-1 within the sensor data. The captured sensor data can include images, laser scan data, point cloud data, or the like. Identifying the incapacitated mobile robot 120-1 can include detecting the markers 218 and matching the markers 218 to a predetermined pattern, as noted earlier. In other examples, identifying the incapacitated mobile robot 120-1 can include providing at least a portion of the sensor data to a classifier (e.g., a suitable deep learning model, such as a convolutional neural network or the like) trained to identify the mobile robots 120 in images.

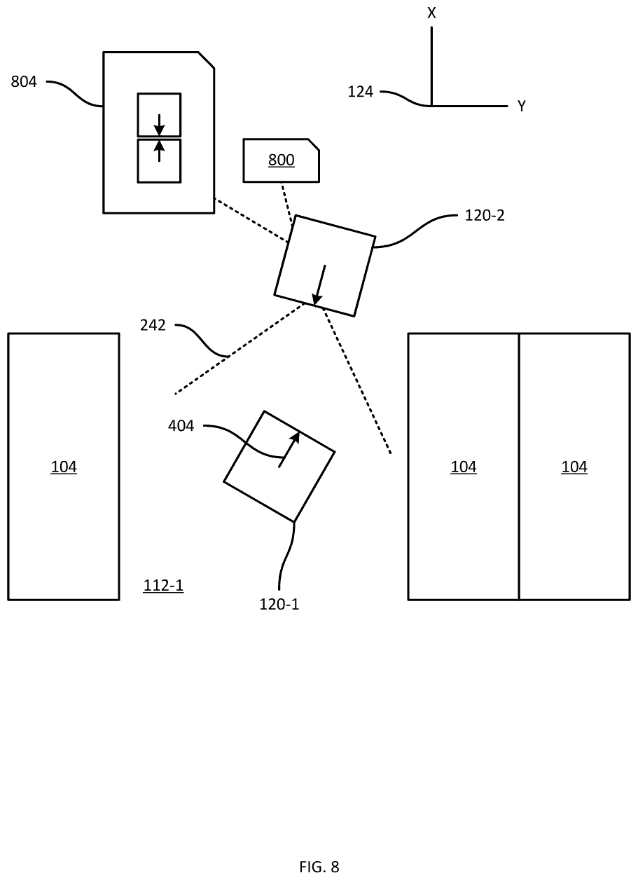

As will be apparent to those skilled in the art, identifying the incapacitated mobile robot 120-1 via sensor data also enables the rescuer mobile robot 120-2 to determine a current pose of the incapacitated mobile robot 120-1. Turning to FIG. 8, the mobile robot 120-2 can store a detected current pose 800 of the mobile robot 120-1, e.g., in the memory 224 for subsequent use to correct the localization of the incapacitated mobile robot 120-1.

In the event that the rescuer robot 120 cannot locate the incapacitated robot 120 in the sensor data, the rescuer robot 120 can send an error message or the like to the server 128. The rescue task can then be terminated, and performance of the method 300 can end. In some scenarios, e.g., when a mobile robot 120 has become incapacitated following a period of mislocalization, the last known pose communicated to the server 128 by the incapacitated mobile robot 120 may be incorrect, and the rescue command 700 may therefore not reflect the true location of the incapacitated mobile robot 120. In such scenarios, rescue of the incapacitated mobile robot 120 may require detection of the incapacitated mobile robot 120 by another mobile robot via block 310 (i.e., discovering the true location of the incapacitated mobile robot 120).

At block 340, responsive to identifying the incapacitated mobile robot 120-1, the mobile robot 120-2 is configured to control its locomotive assembly 204 to position itself in a predetermined pose relative to the robot 120-1. The predetermined pose can be stored in the memory 224 of the mobile robot 120-2, and serves to place the robots 120-1 and 120-2 so as to allow their respective charging interfaces 216 to engage. For example, as shown in FIG. 8, the mobile robot 120-2 can store alignment data 804 defining the relative position to be used at block 340. The alignment data is shown graphically in FIG. 8, but in other examples can be defined by a set of coordinates and/or orientation angles relative to the incapacitated robot 120. The mobile robot 120-2 can navigate towards the mobile robot 120-1, e.g., capturing additional sensor data and updating control of the locomotive assembly 204 to approach the mobile robot 120-1 according to the alignment data 804. The predetermined pose places the charging interfaces 216 of the mobile robots within a charging distance of one another. The charging distance can vary according to, for example, whether the charging interfaces 216 are wired or wireless. For example, the charging distance may be zero for wired charging interfaces 216, or a distance of no more than an upper limit (e.g., 5 centimeters) for wireless charging interfaces 216.

In the event that the mobile robot 120-2 is unable to place itself relative to the mobile robot 120-2 according to the alignment data 804 (e.g., if the mobile robot 120-1 is too close to a support structure 104 or other obstacle), the mobile robot 120-2 can transmit an error message to the server 128, and performance of the method 300 can end. In such cases, the server 128 may transmit a notification to service staff in the facility 100 to manually locate and retrieve the mobile robot 120-1.

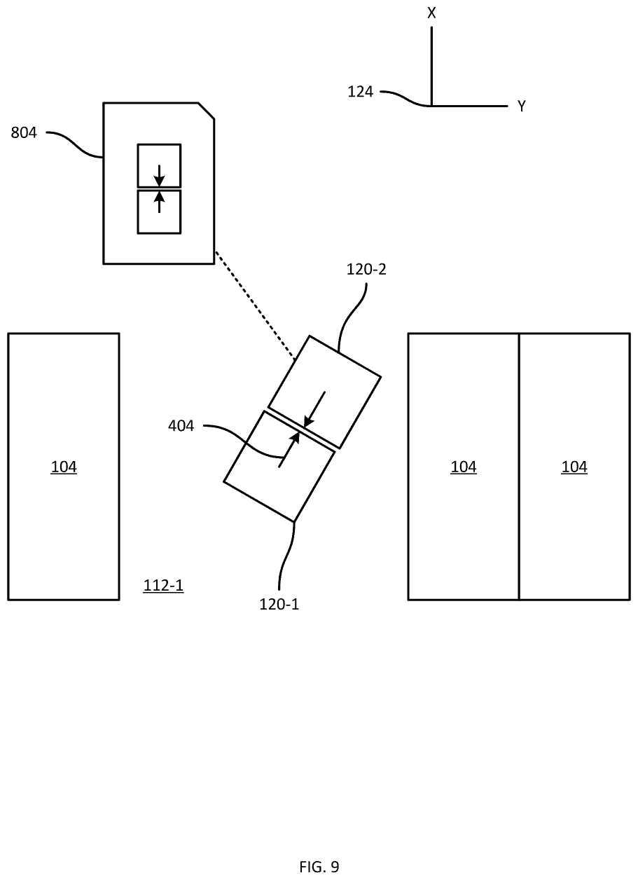

FIG. 9 illustrates the mobile robot 120-2 following completion of block 340. At block 345, in response to positioning itself relative to the incapacitated mobile robot 120-1, the mobile robot 120-2 is configured to charge the battery 244 of the incapacitated mobile robot 120-1. For example, the mobile robot 120-2 can be configured to control the charging interface 216 to being transferring energy to the mobile robot 120-1 (via the charging interface 216 of the mobile robot 216-1). The mobile robot 120-2 can continue charging the mobile root 120-2 until, for example, the charge level of the battery 244 of the mobile robot 120-2 has dropped by the amount specified in the command 700. In other examples, charging can continue until the charge level of the battery 244 of the mobile robot 120-2 has reached a lower threshold (e.g., 30% or any other suitable threshold).

When charging of the incapacitated mobile robot 120-1 is complete, at block 350 the rescuer mobile robot 120-2 can optionally determine whether the incapacitated mobile robot 120-1 is mislocalized. For example, if the true pose of the mobile robot 120-1 determined at block 355 differs from the last known pose from the command 700 by more than a relocalization threshold distance and/or angle of orientation, the determination at block 350 is affirmative. When the determination at block 350 is affirmative, the mobile robot 120-2 can transmit a corrected pose for the mobile robot 120-1 to either or both of the mobile robot 120-1 and the server 128. The corrected pose may allow the mobile robot 120-1 to more quickly recover its localization following charging. In other examples, the mobile robot 120-2 can transmit the pose detected at block 335 regardless of whether the detected pose differs significantly from the last known pose of the mobile robot 120-1.

Following the performance of block 355, or following a negative determination at block 350, the performance of the method 300 ends, and the rescuer mobile robot 120-2 can proceed with a previously assigned, task, await a further task assignment from the server 128, or the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
controlling a locomotive assembly of a first mobile robot to travel towards a rescue location corresponding to a second mobile robot having an incapacitated state;
capturing, using a sensor of the first mobile robot, sensor data representing the rescue location;
at the first mobile robot, detecting the second mobile robot from the sensor data;
controlling the locomotive assembly to position the first mobile robot in a predetermined pose relative to the second mobile robot; and
controlling a charging interface of the first mobile robot to transfer energy from a battery of the mobile robot to a battery of the second mobile robot.

2. The method of claim 1, further comprising obtaining the rescue location by: receiving a rescue command containing the rescue location at the first mobile robot from a central server.

3. The method of claim 1, further comprising: determining that the second mobile robot is in the incapacitated state.

4. The method of claim 3, further comprising:
sending a message to the central server including a detected location of the second mobile robot.

5. The method of claim 3, wherein determining that the second mobile robot is in the incapacitated state includes:
determining that the second mobile robot is not generating wireless transmissions.

6. The method of claim 3, wherein determining that the second mobile robot is in the incapacitated state includes:
receiving a wireless transmission from the second mobile robot indicating that the second mobile robot is in the incapacitated state.

7. The method of claim 1, wherein controlling the locomotive assembly to position the mobile robot in the predetermined pose includes:
detecting a marker affixed to the incapacitated mobile robot;
retrieving alignment data defining the predetermined pose relative to the marker; and
controlling the locomotive assembly according to the alignment data.

8. The method of claim 1, wherein detecting the second mobile robot includes at least one of (i) identifying a set of reflective markers in the sensor data that match a predetermined pattern, or (ii) executing an image classifier to generate a location of the second mobile robot from the sensor data.

9. The method of claim 1, wherein controlling the locomotive assembly to position the first mobile robot in the predetermined pose relative to the second mobile robot includes placing the charging interface of the first mobile robot within a charging distance of a charging interface of the second mobile robot.

10. The method of claim 1, further comprising:
determining, based on a current pose of the mobile robot and the sensor data, a corrected pose of the incapacitated robot; and
transmitting the corrected pose to at least one of the central server and the incapacitated robot.

11. The method of claim 9, wherein the rescue command includes a last known pose of the incapacitated robot; and wherein the method further comprises:
prior to transmitting the corrected pose, determining that a difference between the corrected pose and the last known pose exceeds a relocalization threshold.

12. A mobile robot, comprising:
a sensor;
a charging interface;
a locomotive assembly; and
a processor configured to:
control the locomotive assembly of the mobile robot to travel towards a rescue location corresponding to a second mobile robot having an incapacitated state;
capture, using the sensor, sensor data representing the rescue location;
detect the second mobile robot from the sensor data;
control the locomotive assembly to position the mobile robot in a predetermined pose relative to the second mobile robot; and
control a charging interface of the mobile robot to transfer energy from a battery of the mobile robot to a battery of the second mobile robot.

13. The mobile robot of claim 12, wherein the processor is configured to obtain the rescue location by receiving a rescue command containing the rescue location from a central server.

14. The mobile robot of claim 12, wherein the processor is further configured to determine that the second mobile robot is in the incapacitated state.

15. The mobile robot of claim 14, wherein the processor is further configured to:
send a message to the central server including a detected location of the second mobile robot.

16. The mobile robot of claim 14, wherein the processor is further configured to determine that the second mobile robot is in the incapacitated state by:
determining that the second mobile robot is not generating wireless transmissions.

17. The mobile robot of claim 14, wherein the processor is further configured to determine that the second mobile robot is in the incapacitated state by:
receiving a wireless transmission from the second mobile robot indicating that the second mobile robot is in the incapacitated state.

18. The mobile robot of claim 12, wherein the processor is configured to control the locomotive assembly to position the mobile robot in the predetermined pose by:
detecting a marker affixed to the incapacitated mobile robot;
retrieving alignment data defining the predetermined pose relative to the marker; and
controlling the locomotive assembly according to the alignment data.

19. The mobile robot of claim 12, wherein the processor is further configured to detect the second robot by at least one of (i) identifying a set of reflective markers in the sensor data that match a predetermined pattern, or (ii) executing an image classifier to generate a location of the second mobile robot from the sensor data.

20. The mobile robot of claim 12, wherein the processor is further configured to control the locomotive assembly to position the mobile robot in the predetermined pose relative to the second mobile robot by placing the charging interface of the mobile robot within a charging distance of a charging interface of the second mobile robot.

21. The mobile robot of claim 12, wherein the processor is further configured to:
determine, based on a current pose of the mobile robot and the sensor data, a corrected pose of the incapacitated robot; and
transmit the corrected pose to at least one of the central server and the incapacitated robot.

22. The mobile robot of claim 19, wherein the rescue command includes a last known pose of the incapacitated robot; and wherein the processor is further configured to:
prior to transmitting the corrected pose, determining that a difference between the corrected pose and the last known pose exceeds a relocalization threshold.

23. A method, comprising:
receiving, at a first mobile robot, a rescue command containing a rescue location corresponding to a second mobile robot having an incapacitated state;
controlling a locomotive assembly of the first mobile robot to travel towards the rescue location;
capturing sensor data using a sensor of the first mobile robot, and detecting a current pose of the second mobile robot from the sensor data;
determining that a difference between a last known pose of the second mobile robot and the detected current pose of the second mobile robot exceeds a relocalization threshold; and
transmitting the detected current pose to the second mobile robot.
